(19) United States
(12) Patent Application Publication
(10) Pub. No.: US 2022/0155087 A1
(43) Pub. Date: May 19, 2022

(54) MAP DATA PROCESSING METHOD, DEVICE, STORAGE MEDIUM AND PROGRAM PRODUCT

(71) Applicant: BEIJING BAIDU NETCOM SCIENCE TECHNOLOGY CO., LTD., Beijing (CN)

(72) Inventors: Taotao ZHAO, Beijing (CN); Jiankang XIN, Beijing (CN); Junjie ZHONG, Beijing (CN)

(21) Appl. No.: 17/591,687

(22) Filed: Feb. 3, 2022

(30) Foreign Application Priority Data
Apr. 22, 2021 (CN) 202110437440.3

(51) Int. Cl. G01C 21/36; G01C 21/00

(52) U.S. Cl. CPC G01C 21/367; G01C 21/3867; G01C 21/3881

(57) ABSTRACT

The present disclosure discloses a map data processing method, a device, a storage medium and a program product, and relates to intelligent transportation, automatic driving, electronic map and other fields in computer technology. A specific solution is: determining, according to coordinates of vertexes of a tile included in panoramic map data, coordinates of mapping points of the tile on a plane where a viewport is located; determining a bounding box of the mapping points according to the coordinates of the mapping points; according to whether there is an overlapping area between the bounding box of the mapping points and a visible range corresponding to the viewport, determining whether the tile falls within the visible range, thus determining the indexes of all the tiles falling within the visible range. In this way, the indexes of the tiles falling within the visible range corresponding to the current viewport can be determined accurately.

### CROSS-REFERENCE TO RELATED APPLICATIONS

This application claims priority to Chinese Patent Application No. 202110437440.3, filed on Apr. 22, 2021, entitled “Map Data Processing Method, Device, Storage Medium and Program Product”, which is incorporated herein by reference in its entirety.

### TECHNICAL FIELD

The present disclosure relates to intelligent transportation, automatic driving, electronic map and others in the field of computer technology, and in particular, to a map data processing method, a device, a storage medium and a program product.

### BACKGROUND

Under a panoramic scene of an electronic map, one can browse a panoramic map of a certain geographical position. A panoramic layer corresponding to the position includes a large number of tiles, so the efficiency of loading the panoramic layer is slow and the performance consumption is high. Currently, a manner of loading on demand is generally adopted to load tiles falling within a viewport in order to increase the loading speed.

Currently, it is judged whether tiles fall within the visible area corresponding to the current screen by calculating whether the azimuth angle of each tile coincides with the current screen orientation. However, the calculation efficiency of the azimuth angle of each tile is low and the error is large, which leads to low efficiency and inaccuracy in determining the tile that falls within the visible range, and thus leads to low efficiency and low accuracy of map data display.

### SUMMARY

The present disclosure provides a map data processing method, a device, and a storage medium.

According to a first aspect of the present disclosure, a map data processing method is provided, including:
in response to a display request for panoramic map data of a designated geographical position, determining, according to coordinates of vertexes of a tile included in the panoramic map data, coordinates of mapping points of the tile on a plane where a viewport is located;
determining a bounding box of the mapping points according to the coordinates of the mapping points;
if there is an overlapping area between the bounding box of the mapping points and a visible range corresponding to the viewport, determining that the tile falls within the visible range;
obtaining the tile that falls within the visible range, and performing display processing on the tile.

According to a second aspect of the present disclosure, an electronic device is provided, including:
at least one processor; and
a memory communicatively connected with the at least one processor; where,
the memory stores instructions executable by the at least one processor, and the instructions are executed by the at least one processor to enable the at least one processor to execute the method of the first aspect.

According to a third aspect of the present disclosure, a non-transitory computer-readable storage medium having computer instructions stored thereon is provided, where the computer instructions are used to cause a computer to execute the method of the first aspect.

It should be understood that the content described in this part is not intended to identify key or important features of embodiments of the present disclosure, nor is it used to limit the scope of the present disclosure. Other features of the present disclosure will be easily understood through the following description.

### BRIEF DESCRIPTION OF DRAWINGS

The drawings are used for a better understanding of the solutions and do not constitute a limitation on the present disclosure. Among them:

FIG. 1 is a diagram of a scene of panoramic map data processing that can implement embodiments of the present disclosure.

FIG. 2 is a flowchart of a map data processing method provided by a first embodiment of the present disclosure.

FIG. 3 is a flowchart of a map data processing method provided by a second embodiment of the present disclosure.

FIG. 4 is a schematic diagram of a map data processing apparatus provided by a third embodiment of the present disclosure.

FIG. 5 is a schematic diagram of a map data processing apparatus provided by a fourth embodiment of the present disclosure.

FIG. 6 is a block diagram of an electronic device for implementing a map data processing method of embodiments of the present disclosure.

### DESCRIPTION OF EMBODIMENTS

The following description of exemplary embodiments of the present disclosure will be made with reference to the accompanying drawings, where various details of the embodiments of the present disclosure are included to facilitate understanding, and should be regarded as exemplary only. Therefore, those of ordinary skill in the art should recognize that various changes and modifications can be made to the embodiments described herein without departing from the scope and spirit of the present disclosure. Similarly, for clarity and conciseness, descriptions of well-known functions and structures are omitted in the following description.

The present disclosure provides a map data processing method, which is applied to the fields of intelligent transportation, automatic driving, electronic map and the like in computer technology, to improve the efficiency and accuracy of display of panoramic map data.

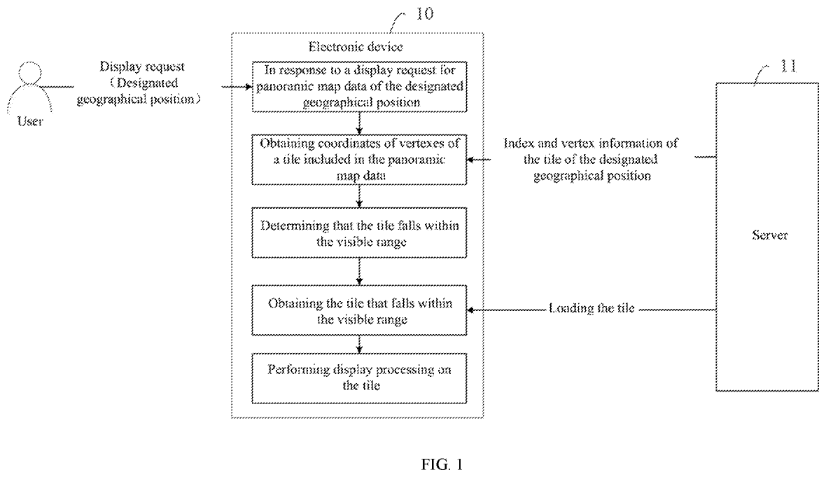

The map data processing method provided in the present disclosure can be applied to a request and display process of map data under a map panoramic scene, and specifically, to a scene of opening panoramic map data of a certain geographical position. As shown in FIG. 1, a user selects a designated geographical position through an interactive interface provided by an electronic device 10, and sends a display request for panoramic map data of the designated geographical position to the electronic device. In response to the display request, the electronic device can obtain coordinates of vertexes of a tile included in the panoramic map data from a server 11, and determine coordinates of mapping points of the tile on a plane where a viewport is located according to the coordinates of the vertexes of the tile included in the panoramic map data; determine a bounding box of the mapping points according to the coordinates of the mapping points; if there is an overlapping area between the bounding box of the mapping points and a visible range corresponding to the viewport, determine that the tile falls within the visible range, which can obtain the tile falling into the visible range corresponding to the viewport accurately. By obtaining the tile falling into the visible range and performing display processing on the tile, the panoramic map data can be loaded and displayed on demand, thereby improving the efficiency and accuracy of panoramic map display.

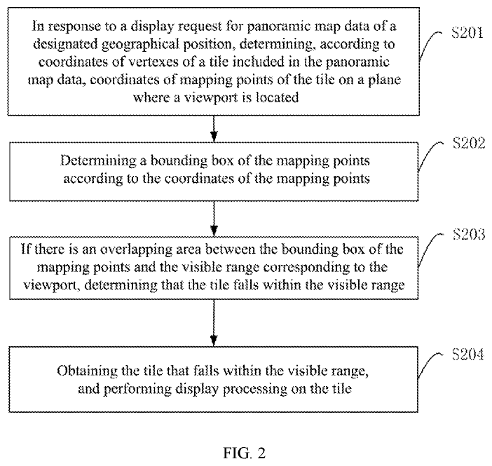

FIG. 2 is a flowchart of a map data processing method provided by a first embodiment of the present disclosure. The executive entity of this embodiment may be an electronic device for providing panoramic map traffic of an electronic map and functions such as navigation, which may specifically be a mobile terminal such as a smart phone, a tablet computer and a laptop, and may also be a vehicular terminal on a vehicle, or a fixed terminal, etc. This embodiment takes the electronic device as an example for illustration. As shown in FIG. 2, specific steps of this method are as follows.

Step S201, in response to a display request for panoramic map data of a designated geographical position, determining, according to coordinates of vertexes of a tile included in the panoramic map data, coordinates of mapping points of the tile on a plane where a viewport is located.

In practical applications, electronic devices of different sizes usually have different sizes of viewports. A viewport may be related to a screen of an electronic device, and may also be related to the size of a window presented by the electronic device.

The panoramic map data of the designated geographical position includes multiple tiles. Based on the current viewport, some of the tiles fall within a visible range corresponding to the viewport, while the other tiles do not fall within the visible range corresponding to the viewport. In order to improve the loading and display efficiency of the map data, it is possible to obtain and display only tiles falling within the visible range corresponding to the viewport on demand.

In this step, in response to the display request for the panoramic map data of the designated geographical position, the electronic device will determine coordinates of mapping points of each tile on the plane where the viewport is located according to the coordinates of the vertexes of the tile included in the panoramic map data.

The mapping points may be mapping points, on the plane where the viewport is located, of the vertexes of the tile, or the mapping points may be mapping points, on the plane, of vertexes of a bounding box of the vertexes of the tile, which can determine an area covered by the tile after the tile is mapped to the plane where the viewport is located.

Step S202, determining a bounding box of the mapping points according to the coordinates of the mapping points.

After the coordinates of the mapping points of the tile on the plane where the viewport is located are determined, the bounding box of the mapping points is determined according to the coordinates of the mapping points, and the bounding box of the mapping points can reflect an area covered by the tile after the tile is mapped to a three-dimensional space where the visible range corresponding to the viewport is located.

The bounding box of the mapping points may be an AABB (axis-aligned bounding boxes) bounding box, an oriented bounding box (OBB for short), or a k-DOP (k discrete oriented polytope) bounding box of the mapping points, etc. In addition, the bounding box of the mapping points may also be other types of bounding boxes determined according to other bounding box calculation algorithms, which is not specifically limited here in this embodiment.

Step S203, if there is an overlapping area between the bounding box of the mapping points and the visible range corresponding to the viewport, determining that the tile falls within the visible range.

After the bounding box of the mapping points is determined, it can be determined whether the tile falls within the visible range, according to whether there is an overlapping area between the bounding box of the mapping points and the visible range corresponding to the viewport, so that indexes of all the tiles falling within the visible range can be determined.

Step S204, obtaining the tile that falls within the visible range, and performing display processing on the tile.

After determining the tile falling within the visible range corresponding to the viewport, the tile falling into the visible range can be obtained and display processing can be performed, so that the tile falling within the visible range corresponding to the viewport can be displayed, to realize display of the panoramic map data of the designated geographical position.

According to the embodiment of the present disclosure, the coordinates of the mapping points of the tile on the plane where the viewport is located are determined according to the coordinates of the vertexes of the tile included in the panoramic map data; the bounding box of the mapping points is determined according to the coordinates of the mapping points; according to whether there is an overlapping area between the bounding box of the mapping points and the visible range corresponding to the viewport, whether the tile falls within the visible range is determined, thus the indexes of all the tiles falling within the visible range are determined. In this way, the indexes of the tiles falling within the visible range corresponding to the current viewport can be determined accurately, thereby reducing the time complexity of calculation, improving the accuracy of determining the tiles falling within the visible range corresponding to the viewport, realizing the accurate on-demand loading of the tiles falling within the visible range, and improving the efficiency and accuracy of display of a panoramic map.

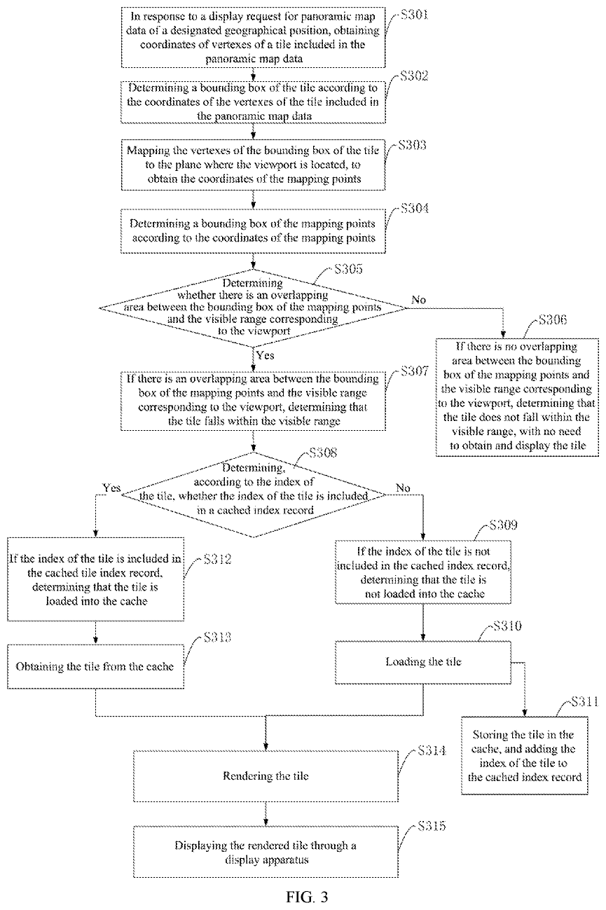

FIG. 3 is a flowchart of a map data processing method provided by a second embodiment of the present disclosure. On the basis of the above first embodiment, in this embodiment, the determination of the coordinates of the mapping points of the tile on the plane where the viewport is located according to the coordinates of the vertexes of the tile included in the panoramic map data can be realized in the following ways: determining a bounding box of the tile according to the coordinates of the vertexes of the tile included in the panoramic map data; and mapping vertexes of the bounding box of the tile to the plane where the viewport is located, to obtain the coordinates of the mapping points. In this embodiment, a loaded tile can be stored in a cache, and an index of the loaded tile can be stored in a cached tile index record. When it is determined that the tile falls within the visible range corresponding to the viewport and the tile needs to be obtained, the tile is preferentially obtained from the cache, and if it does not exist in the cache, then the tile is loaded from a server.

As shown in FIG. 3, the specific steps of this method are as follows.

Step S301, in response to a display request for panoramic map data of a designated geographical position, obtaining coordinates of vertexes of a tile included in the panoramic map data.

In this embodiment, in response to the display request for the panoramic map data of the designated geographical position, the electronic device can obtain an index of the tile included in the corresponding panoramic map data and the coordinates of the vertexes of the tile according to the designated geographical position, so as to provide a data basis for subsequent determination of whether the tile falls within a visible range corresponding to a viewport.

The panoramic map data of the designated geographical position includes multiple tiles. Based on the current viewport, some of the tiles fall within the visible range corresponding to the viewport, while the other tiles do not fall within the visible range corresponding to the viewport. In order to improve the loading and display efficiency of the map data, it is possible to obtain and display only tiles falling within the visible range corresponding to the viewport on demand.

Exemplarily, the electronic device can send a tile information request including a designated geographical position to a server, and the server can determine indexes of all the tiles included in the panoramic map data corresponding to the designated geographical position and coordinates of vertexes of all the tiles according to the designated geographical position, and feed them back to the electronic device.

Exemplarily, if the electronic device stores information of all the tiles included in the panoramic map data corresponding to the designated geographical position locally, the electronic device directly searches for and obtains the indexes of all the tiles included in the panoramic map data corresponding to the designated geographical position and the coordinates of the vertexes of all the tiles from the local.

In an optional implementation of this embodiment, after obtaining the coordinates of the vertexes of the tile included in the panoramic map data of the designated geographical position, the vertexes of the tile can also be mapped to a plane where the viewport is located, to obtain coordinates of mapping points of the tile on the plane where the viewport is located. Based on the coordinates of the mapping points of the tile on the plane where the viewport is located, whether the tile falls within the visible range corresponding to the viewport can be accurately determined.

In another optional implementation of this embodiment, after obtaining the coordinates of the vertexes of the tile included in the panoramic map data of the designated geographical position, the determination of the coordinates of the mapping points of the tile on the plane where the viewport is located according to the coordinates of the vertexes of the tile included in the panoramic map data can be determined according to the following steps S302-S303.

Step S302, determining a bounding box of the tile according to the coordinates of the vertexes of the tile included in the panoramic map data.

In this step, a bounding box of the vertexes of each tile can be determined according to the coordinates of the vertexes of the tile, and the bounding box of the vertexes of the tile is also the bounding box of the tile.

Exemplarily, the bounding box of the tile may be an AABB bounding box of the vertexes of the tile, an OBB bounding box of the vertexes of the tile, or a k-DOP bounding box of the vertexes of the tile, etc. In addition, the bounding box of the tile may also be other types of bounding boxes determined according to other bounding box calculation algorithms, which is not specifically limited here in this embodiment.

Exemplarily, when determining the bounding box of the vertexes of the tile, maximum and minimum values on each coordinate axis can be calculated respectively according to three-dimensional coordinates of all the vertexes of the tile. Based on the maximum and minimum values on three coordinate axes, eight points can be obtained by combination and used as vertexes of the bounding box of the vertexes of the tile, to obtain the bounding box of the vertexes of the tile.

After the bounding box of the tile is determined, a set of vertexes included in the bounding box of the tile can be obtained.

For example, taking an AABB bounding box as an example, a set of vertexes included in the bounding box can be represented as A, A={a0(x0, y0, z0), a1(x1, y1, z1), a7(x7, y7, z7)}, where A includes 8 vertexes, a0(x0, y0, z0) represents one vertex of the bounding box, the coordinates of this vertex is (x0, y0, z0); a1(x1, y1, z1), a7(x7, y7, z7) represent other two vertexes of the bounding box. Other vertexes can also be represented in a similar way, and will not be enumerated here.

By traversing all the tiles included in the panoramic map data of the designated geographical position, bounding boxes of all the tiles included in the panoramic map data of the designated geographical position can be obtained.

Exemplarily, a set consisting of the sets of vertexes of the bounding boxes of all the tiles included in the panoramic map data of the designated geographical position can be represented as W. Assuming that the number of tiles included in the panoramic map data of the designated geographical position is n, then W={A0, A1, A2, . . . Ai . . . , An}, where A0, A1, A2, . . . Ai . . . , An respectively represent the sets of vertexes of the bounding boxes of n tiles.

Step S303, mapping the vertexes of the bounding box of the tile to the plane where the viewport is located, to obtain the coordinates of the mapping points.

After the vertexes of the bounding box of the tile are determined, the vertexes of the bounding box of the tile can be mapped to the plane where the viewport is located, to obtain the coordinates of the mapping points.

Exemplarily, the vertexes of the bounding box of the tile are mapped to the plane where the viewport is located via a projection interface (GL interface), to obtain the coordinates of the mapping points.

In this implementation, through the above steps S302-S303, the vertexes of the bounding box of the tile are mapped to the plane where the viewport is located, and the coordinates of the mapping points are obtained, so that the tile can be mapped to the plane where the viewport is located more accurately, and based on the coordinates of the mapping points, whether the tile falls within the visible range corresponding to the viewport can be determined more accurately.

Step S304, determining a bounding box of the mapping points according to the coordinates of the mapping points.

After the coordinates of the mapping points of the tile on the plane where the viewport is located are determined, the bounding box of the mapping points can be determined.

Exemplarily, the bounding box of the mapping points may be an AABB bounding box, an OBB bounding box, or a k-DOP bounding box of the mapping points, etc. In addition, the bounding box of the mapping points may also be other types of bounding boxes determined according to other bounding box calculation algorithms, which is not specifically limited here in this embodiment.

By traversing all the tiles included in the panoramic map data of the designated geographical position to execute the steps S302-S304, the bounding boxes of the mapping points corresponding to all the tiles included in the panoramic map data of the designated geographical position can be obtained.

Step S305, determining whether there is an overlapping area between the bounding box of the mapping points and the visible range corresponding to the viewport.

After the bounding box of the mapping points corresponding to the tile is obtained, whether the tile falls within the visible range corresponding to the viewport can be accurately determined according to whether there is an overlapping area between the bounding box of the mapping points and the visible range corresponding to the viewport, and the loading efficiency of the tile can be greatly optimized. Especially in some scenes where panoramic layers need to be frequently switched and loaded, the time complexity of an algorithm for determining the index of the tile falling within the visible range is reduced from O(n²) in the prior art to O(n). In actual interactive scenes, the traffic of panoramic layer loading can be greatly saved, improving the recording efficiency.

Exemplarily, in this step, whether there is an overlapping area between the bounding box of the mapping points and the visible range corresponding to the viewport can be determined by a collision detection method, or it can be realized using any existing method that can realize this function, which is not specifically limited here in this embodiment.

If there is no overlapping area between the bounding box of the mapping points and the visible range corresponding to the viewport, it is determined that the tile does not fall within the visible range, and there is no need to obtain and display the tile.

If there is an overlapping area between the bounding box of the mapping points and the visible range corresponding to the viewport, it is determined that the tile falls within the visible range, and steps S306-S315 are executed to obtain and display the tile falling into the visible range corresponding to the viewport, so as to realize the on-demand obtaining and display of the tile.

Step S306, if there is no overlapping area between the bounding box of the mapping points and the visible range corresponding to the viewport, determining that the tile does not fall within the visible range, with no need to obtain and display the tile.

Step S307, if there is an overlapping area between the bounding box of the mapping points and the visible range corresponding to the viewport, determining that the tile falls within the visible range.

In this embodiment, after determining that the tile falls within the visible range corresponding to the viewport, the tile falling within the visible range corresponding to the viewport can be obtained by the following steps S308-S313.

Step S308, determining, according to the index of the tile, whether the index of the tile is included in a cached tile index record.

In this embodiment, the electronic device can cache a loaded tile, and record the index of the cached tile by storing the cached tile index record. For the tile that falls within the visible range corresponding to the viewport, if the tile is not loaded, then load the tile; if the tile is loaded, that is, the tile has been cached, then read the tile from a cache, which can reduce the process of repeated loading of the tile, save the loading traffic of the tile, and improve the loading efficiency of the tile.

In this step, if the index of the tile is not included in the cached tile index record, then steps S309-S310 are executed to determine that the tile is not loaded into the cache, and load the tile from the server.

If the index of the tile is included in the cached tile index record, then steps S312-S313 are executed to determine that the tile is loaded into the cache and obtain the tile from the cache.

Step S309, if the index of the tile is not included in the cached tile index record, determining that the tile is not loaded into the cache.

Step S310, loading the tile.

Exemplarily, the tile can be stored on the server, and when needed, the electronic device loads the tile from the server to the local.

Step S311, storing the tile in the cache, and adding the index of the tile to the cached tile index record.

After the tile is loaded, the tile is stored in the cache, and the index of the tile is added to the cached tile index record, so that next time the tile needs to be loaded, the tile can be directly obtained from the cache.

Step S312, if the index of the tile is included in the cached tile index record, determining that the tile is loaded into the cache.

Step S313, obtaining the tile from the cache.

Exemplarily, the tile can be read from the cache based on the index of the tile, improving the efficiency of searching for and reading the tile.

After the tile falling within the visible range corresponding to the viewport is obtained, display processing is performed on the obtained tile by the following steps S314-S315, so that the display of the tile falling within the visible range corresponding to the viewport is realized, and thus the panoramic map data of the designated geographical position is accurately presented to a user.

Step S314, rendering the tile.

Exemplarily, by rendering the tile, tile drawing is realized to obtain the tile to be displayed, and rendered tiles are combined to form a panoramic map of the designated geographical position.

The rendering of the tile can be realized using a method for generating a to-be-displayed tile by drawing and rendering in the prior art, which will not be repeated here in this embodiment.

Step S315, displaying the rendered tile through a display apparatus.

The display apparatus may be a display screen.

After the rendered tile is obtained, the rendered tile is displayed within a corresponding area on a front-end page, thus realizing the display of the panoramic map of the designated geographical position.

According to the embodiment of the present disclosure, the bounding box of the tile is determined according to the coordinates of the vertexes of the tile included in the panoramic map data; the vertexes of the bounding box of the tile are mapped to the plane where the viewport is located, to obtain the coordinates of the mapping points; the bounding box of the mapping points is determined according to the coordinates of the mapping points; according to whether there is an overlapping area between the bounding box of the mapping points and the visible range corresponding to the viewport, whether the tile falls within the visible range is determined, thus the indexes of all the tiles falling within the visible range are determined. In this way, the indexes of the tiles falling within the visible range corresponding to the current viewport can be determined accurately, thereby reducing the time complexity of calculation, and improving the accuracy of determining the tiles falling within the visible range corresponding to the viewport. Further, the loaded tile is cached, and the index of the cached tile is recorded by storing the cached tile index record. For the tile falling within the visible range corresponding to the viewport, if the tile is not loaded, then the tile is loaded; if the tile is loaded, that is, the tile has been cached, then the tile is read from the cache, which can reduce the process of repeated loading of the tile, and save the loading traffic of the tile, thereby further improving the loading efficiency of the tile, realizing the accurate on-demand loading of the tile falling within the visible range, and improving the efficiency and accuracy of display of the panoramic map.

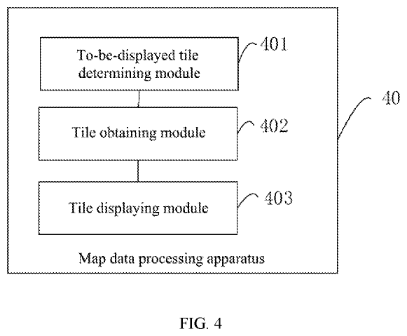

FIG. 4 is a schematic diagram of a map data processing apparatus provided by a third embodiment of the present disclosure. The map data processing apparatus provided by this embodiment can execute the processing flow provided by the embodiments of the map data processing method. As shown in FIG. 4, a map data processing apparatus 40 includes: a to-be-displayed tile determining module 401, a tile obtaining module 402 and a tile displaying module 403.

Specifically, the to-be-displayed tile determining module 401 is configured to: in response to a display request for panoramic map data of a designated geographical position, determine, according to coordinates of vertexes of a tile included in the panoramic map data, coordinates of mapping points of the tile on a plane where a viewport is located; determine a bounding box of the mapping points according to the coordinates of the mapping points; if there is an overlapping area between the bounding box of the mapping points and a visible range corresponding to the viewport, determine that the tile falls within the visible range.

The tile obtaining module 402 is configured to obtain the tile that falls within the visible range.

The tile displaying module 403 is configured to perform display processing on the tile.

The apparatus provided by this embodiment can be specifically configured to execute the method embodiment provided by the above first embodiment, and the specific functions will not be repeated here.

According to the embodiment of the present disclosure, the coordinates of the mapping points of the tile on the plane where the viewport is located are determined according to the coordinates of the vertexes of the tile included in the panoramic map data; the bounding box of the mapping points is determined according to the coordinates of the mapping points; according to whether there is an overlapping area between the bounding box of the mapping points and the visible range corresponding to the viewport, whether the tile falls within the visible range is determined, thus the indexes of all the tiles falling within the visible range are determined. In this way, the indexes of the tiles falling within the visible range corresponding to the current viewport can be determined accurately, thereby reducing the time complexity of calculation, improving the accuracy of determining the tiles falling within the visible range corresponding to the viewport, realizing the accurate on-demand loading of the tiles falling within the visible range, and improving the efficiency and accuracy of display of a panoramic map.

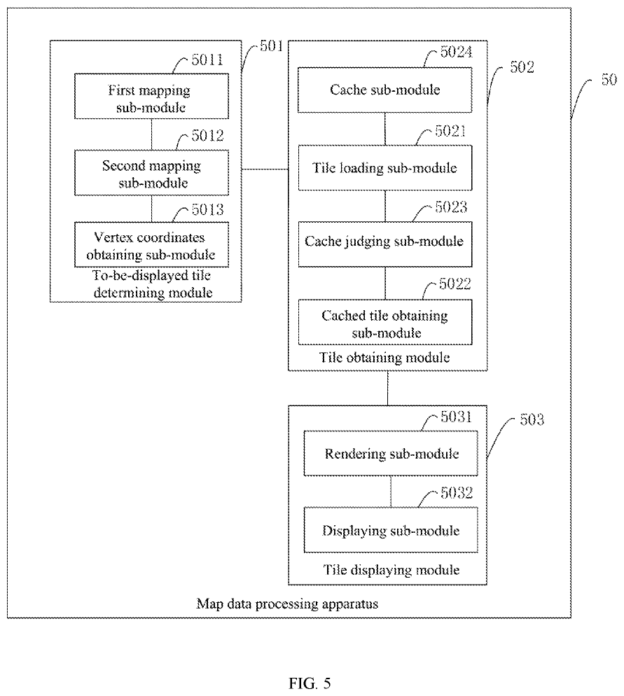

FIG. 5 is a schematic diagram of a map data processing apparatus provided by a fourth embodiment of the present disclosure. The map data processing apparatus provided by this embodiment can execute the processing flow provided by the embodiments of the map data processing method. As shown in FIG. 5, the map data processing apparatus 50 includes: a to-be-displayed tile determining module 501, a tile obtaining module 502 and a tile displaying module 503.

Specifically, the to-be-displayed tile determining module 501 is configured to: in response to a display request for panoramic map data of a designated geographical position, determine, according to coordinates of vertexes of a tile included in the panoramic map data, coordinates of mapping points of the tile on a plane where a viewport is located; determine a bounding box of the mapping points according to the coordinates of the mapping points; if there is an overlapping area between the bounding box of the mapping points and a visible range corresponding to the viewport, determine that the tile falls within the visible range.

The tile obtaining module 502 is configured to obtain the tile that falls within the visible range.

The tile displaying module 503 is configured to perform display processing on the tile.

In an optional implementation, as shown in FIG. 5, the to-be-displayed tile determining module 501 includes:
a first mapping sub-module 5011, configured to:
determine a bounding box of the tile according to the coordinates of the vertexes of the tile included in the panoramic map data; map vertexes of the bounding box of the tile to the plane where the viewport is located, to obtain the coordinates of the mapping points.

In an optional implementation, as shown in FIG. 5, the to-be-displayed tile determining module 501 includes:
a second mapping sub-module 5012, configured to map the vertexes of the tile to the plane where the viewport is located, to obtain the coordinates of the mapping points.

In an optional implementation, as shown in FIG. 5, the to-be-displayed tile determining module 501 further includes:
a vertex coordinates obtaining sub-module 5013, configured to:
obtain the coordinates of the vertexes of the tile included in the panoramic map data, before determining the coordinates of the mapping points of the tile on the plane where the viewport is located according to the coordinates of the vertexes of the tile included in the panoramic map data.

In an optional implementation, as shown in FIG. 5, the tile obtaining module 502 includes:
a tile loading sub-module 5021, configured to load the tile if it is determined that the tile is not loaded into a cache.

In an optional implementation, as shown in FIG. 5, the tile obtaining module 502 further includes:
a cached tile obtaining sub-module 5022, configured to obtain the tile from the cache if it is determined that the tile is loaded into the cache.

In an optional implementation, as shown in FIG. 5, the tile obtaining module 502 further includes:
a cache judging sub-module 5023, configured to:
before obtaining the tile that falls within the visible range, if the index of the tile is not included in a cached tile index record, determine that the tile is not loaded into the cache; if the index of the tile is included in the cached tile index record, determine that the tile is loaded into the cache.

In an optional implementation, as shown in FIG. 5, the tile obtaining module 502 further includes:
a cache sub-module 5024, configured to store the tile in the cache and add the index of the tile to the cached tile index record, after loading the tile if it is determined that the tile is not loaded into the cache.

In an optional implementation, as shown in FIG. 5, the tile displaying module 503 includes:
a rendering sub-module 5031, configured to render the tile;
a displaying sub-module 5032, configured to display a rendered tile through a display apparatus.

The apparatus provided by this embodiment can be specifically used to execute the method embodiment provided by the above first embodiment, and the specific functions will not be repeated here.

According to the embodiment of the present disclosure, the bounding box of the tile is determined according to the coordinates of the vertexes of the tile included in the panoramic map data; the vertexes of the bounding box of the tile are mapped to the plane where the viewport is located, to obtain the coordinates of the mapping points; the bounding box of the mapping points is determined according to the coordinates of the mapping points; according to whether there is an overlapping area between the bounding box of the mapping points and the visible range corresponding to the viewport, whether the tile falls within the visible range is determined, thus the indexes of all the tiles falling within the visible range are determined. In this way, the indexes of the tiles falling within the visible range corresponding to the current viewport can be determined accurately, thereby reducing the time complexity of calculation, and improving the accuracy of determining the tiles falling within the visible range corresponding to the viewport. Further, the loaded tile is cached, and the index of the cached tile is recorded by storing the cached tile index record. For the tile falling within the visible range corresponding to the viewport, if the tile is not loaded, then the tile is loaded; if the tile is loaded, that is, the tile has been cached, then the tile is read from the cache, which can reduce the process of repeated loading of the tile, and save the loading traffic of the tile, thereby further improving the loading efficiency of the tile, realizing the accurate on-demand loading of the tile falling within the visible range, and improving the efficiency and accuracy of display of the panoramic map.

According to embodiments of the present disclosure, the present disclosure also provides an electronic device and a readable storage medium.

According to an embodiment of the present disclosure, the present disclosure also provides a computer program product, which includes: a computer program, which is stored in a readable storage medium. At least one processor of an electronic device can read the computer program from the readable storage medium, and the at least one processor executes the computer program to cause the electronic device to execute the solution provided by any of the above embodiments.

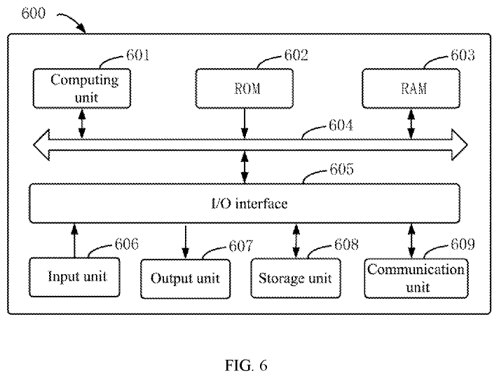

FIG. 6 shows a schematic block diagram of an example electronic device 600 that can be used to implement the embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile apparatuses, such as personal digital assistants, cellular phones, smart phones, wearable devices and other similar computing apparatuses. The components shown herein, their connections and relationships, and their functions are only examples, and are not intended to limit the implementation of the present disclosure described and/or claimed herein.

As shown in FIG. 6, the electronic device 600 includes a computing unit 601, which can execute various appropriate actions and processing according to a computer program stored in a read-only memory (ROM) 602 or a computer program loaded into a random access memory (RAM) 603 from a storage unit 608. In the RAM 603, various programs and data required for operations of the device 600 can also be stored. The computing unit 601, the ROM 602 and the RAM 603 are connected to each other through a bus 604. An input/output (I/O) interface 605 is also connected to the bus 604.

Many components in the device 600 are connected to the I/O interface 605, including an input unit 606, such as a keyboard, a mouse, etc.; an output unit 607, such as various types of displays, speakers, etc.; the storage unit 608, such as a magnetic disk, an optical disk, etc.; and a communication unit 609, such as a network card, a modem, a wireless communication transceiver, etc. The communication unit 609 allows the device 600 to exchange information/data with other devices via a computer network such as the Internet and/or various telecommunication networks.

The computing unit 601 may be various general-purpose and/or special-purpose processing components with processing and computing capabilities. Some examples of the computing unit 601 include, but are not limited to, a central processing unit (CPU), a graphics processing unit (GPU), various dedicated artificial intelligence (AI) computing chips, various computing units running machine learning model algorithms, a digital signal processor (DSP), and any suitable processor, controller, microcontroller, etc. The computing unit 601 executes various methods and processing described above, such as the map data processing method. For example, in some embodiments, the map data processing method may be implemented as a computer software program tangibly embodied in a machine-readable medium such as the storage unit 608. In some embodiments, part or all of the computer program may be loaded and/or installed on the device 600 via the ROM 602 and/or the communication unit 609. When the computer program is loaded into the RAM 603 and executed by the computing unit 601, one or more steps of the map data processing method described above can be executed. Alternatively, in other embodiments, the computing unit 601 may be configured to execute the map data processing method in any other suitable manner (for example, by means of firmware).

Various implementations of the systems and technologies described above herein can be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), computer hardware, firmware, software, and/or their combinations. These various embodiments may include: being implemented in one or more computer programs that can be executed and/or interpreted on a programmable system including at least one programmable processor, which may be a special-purpose or general-purpose programmable processor, and can receive data and instructions from a storage system, at least one input apparatus and at least one output apparatus, and transmit data and instructions to the storage system, the at least one input apparatus and the at least one output apparatus.

The program code for implementing the method of the present disclosure can be written in any combination of one or more programming languages. These program codes can be provided to a processor or controller of a general-purpose computer, a special-purpose computer or other programmable data processing apparatus, so that the program codes, when executed by the processor or controller, cause the functions/operations specified in the flowcharts and/or block diagrams to be implemented. The program codes can be completely executed on a machine, partially executed on a machine, partially executed on a machine and partially executed on a remote machine as an independent software package, or completely executed on a remote machine or server.

In the context of the present disclosure, a machine-readable medium may be a tangible medium that may include or store a program for use by, or for use in connection with, an instruction execution system, an apparatus or a device. The machine-readable medium may be a machine-readable signal medium or a machine-readable storage medium. The machine-readable medium may include, but is not limited to, electronic, magnetic, optical, electromagnetic, infrared, or semiconductor systems, apparatuses or devices, or any suitable combination thereof. More specific examples of the machine-readable storage medium may include electrical connections based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

To provide interaction with users, the systems and technologies described herein can be implemented on a computer having: a display apparatus (for example, CRT (cathode ray tube) or LCD (liquid crystal display) monitor) for displaying information to users; as well as a keyboard and a pointing apparatus (for example, a mouse or a trackball) through which users can provide inputs to the computer. Other kinds of apparatuses can also be used to provide interaction with users, for example, a feedback provided to a user may be any form of sensory feedback (for example, visual feedback, auditory feedback, or tactile feedback); and inputs from the user can be received in any form (including acoustic input, voice input or tactile input).

The systems and technologies described herein can be implemented in a computing system including a back-end component (e.g., as a data server), or a computing system including a middleware component (e.g., an application server), or a computing system including a front-end component (e.g., a user computer with a graphical user interface or a web browser through which users can interact with the implementations of the systems and technologies described herein), or a computing system including any combination of such back-end component, middleware component, or front-end component. The components of the system can be connected to each other by any form or medium of digital data communication (for example, a communication network). Examples of the communication network include a local area network (LAN), a wide area network (WAN) and the Internet.

A computer system can include a client and a server. The client and server are generally far away from each other and usually interact through a communication network. A relationship between the client and the server is generated by computer programs running on corresponding computers and having a client-server relationship with each other. The server may be a cloud server, also known as a cloud computing server or a cloud host, which is a host product in a cloud computing service system to solve the defects of difficult management and weak business scalability in a traditional physical host and VPS service (“Virtual Private Server”, or “VPS” for short). The server may also be a server of a distributed system, or a server combined with a blockchain.

According to the techniques of the present disclosure, the efficiency and accuracy of display of panoramic map data are improved.

It should be understood that steps can be reordered, added or deleted for the various forms of processes shown above. For example, the steps described in the present application can be executed in parallel, sequentially or in a different order, so long as the desired results of the technical solutions disclosed in the present disclosure can be achieved, which is not limited herein.

The above embodiments do not constitute a limitation to the scope of protection of the present disclosure. Those skilled in the art should understand that various modifications, combinations, sub-combinations and substitutions may be made according to design requirements and other factors. Any modification, equivalent substitution, improvement and others that are made within the spirit and principle of the present disclosure should be included in the scope of protection of the present disclosure.

What is claimed is:

1. A map data processing method, comprising:
in response to a display request for panoramic map data of a designated geographical position, determining, according to coordinates of vertexes of a tile comprised in the panoramic map data, coordinates of mapping points of the tile on a plane where a viewport is located;
determining a bounding box of the mapping points according to the coordinates of the mapping points;
if there is an overlapping area between the bounding box of the mapping points and a visible range corresponding to the viewport, determining that the tile falls within the visible range;
obtaining the tile that falls within the visible range, and performing display processing on the tile.

2. The method according to claim 1, wherein determining, according to the coordinates of the vertexes of the tile comprised in the panoramic map data, the coordinates of the mapping points of the tile on the plane where the viewport is located comprises:
determining a bounding box of the tile according to the coordinates of the vertexes of the tile comprised in the panoramic map data;
mapping vertexes of the bounding box of the tile to the plane where the viewport is located, to obtain the coordinates of the mapping points.

3. The method according to claim 1, wherein determining, according to the coordinates of the vertexes of the tile comprised in the panoramic map data, the coordinates of the mapping points of the tile on the plane where the viewport is located comprises:
mapping the vertexes of the tile to the plane where the viewport is located, to obtain the coordinates of the mapping points.

4. The method according to claim 1, before determining, according to the coordinates of the vertexes of the tile comprised in the panoramic map data, the coordinates of the mapping points of the tile on the plane where the viewport is located, further comprising:
obtaining the coordinates of the vertexes of the tile comprised in the panoramic map data.

5. The method according to claim 1, wherein obtaining the tile that falls within the visible range comprises:
loading the tile if it is determined that the tile is not loaded into a cache.

6. The method according to claim 5, wherein obtaining the tile that falls within the visible range further comprises:
obtaining the tile from the cache if it is determined that the tile is loaded into the cache.

7. The method according to claim 5, before obtaining the tile that falls within the visible range, further comprising:
if an index of the tile is not comprised in a cached tile index record, determining that the tile is not loaded into the cache;
if the index of the tile is comprised in the cached tile index record, determining that the tile is loaded into the cache.

8. The method according to claim 7, after loading the tile if it is determined that the tile is not loaded into the cache, further comprising:
storing the tile in the cache, and adding the index of the tile to the cached tile index record.

9. The method according to claim 1, wherein performing display processing on the tile comprises:
rendering the tile;
displaying a rendered tile through a display apparatus.

10. A map data processing apparatus, comprising:
at least one processor; and
a memory communicatively connected with the at least one processor; wherein,
the memory stores instructions executable by the at least one processor, and the instructions are executed by the at least one processor so that the at least one processor is configured to:
in response to a display request for panoramic map data of a designated geographical position, determine, according to coordinates of vertexes of a tile comprised in the panoramic map data, coordinates of mapping points of the tile on a plane where a viewport is located; determine a bounding box of the mapping points according to the coordinates of the mapping points; if there is an overlapping area between the bounding box of the mapping points and a visible range corresponding to the viewport, determine that the tile falls within the visible range;
obtain the tile that falls within the visible range;
perform display processing on the tile.

11. The apparatus according to claim 10, wherein the at least one processor is configured to:
determine a bounding box of the tile according to the coordinates of the vertexes of the tile comprised in the panoramic map data;
map vertexes of the bounding box of the tile to the plane where the viewport is located, to obtain the coordinates of the mapping points.

12. The apparatus according to claim 10, wherein the at least one processor is configured to map the vertexes of the tile to the plane where the viewport is located, to obtain the coordinates of the mapping points.

13. The apparatus according to claim 10, wherein the at least one processor is configured to obtain the coordinates of the vertexes of the tile comprised in the panoramic map data, before determining the coordinates of the mapping points of the tile on the plane where the viewport is located according to the coordinates of the vertexes of the tile comprised in the panoramic map data.

14. The apparatus according to claim 10, wherein the at least one processor is configured to load the tile if it is determined that the tile is not loaded into a cache.

15. The apparatus according to claim 14, wherein the at least one processor is configured to obtain the tile from the cache if it is determined that the tile is loaded into the cache.

16. The apparatus according to claim 14, wherein the at least one processor is configured to: before obtaining the tile that falls within the visible range,
if the index of the tile is not comprised in a cached tile index record, determine that the tile is not loaded into the cache;
if the index of the tile is comprised in a cached tile index record, determine that the tile is loaded into the cache.

17. The apparatus according to claim 16, wherein the at least one processor is configured to store the tile in the cache and add the index of the tile to the cached tile index record, after loading the tile if it is determined that the tile is not loaded into the cache.

18. The apparatus according to claim 10, wherein the at least one processor is configured to:
render the tile;
display a rendered tile through a display apparatus.

19. A non-transitory computer-readable storage medium having computer instructions stored thereon, wherein the computer instructions are used to cause a computer to execute:
in response to a display request for panoramic map data of a designated geographical position, determining, according to coordinates of vertexes of a tile comprised in the panoramic map data, coordinates of mapping points of the tile on a plane where a viewport is located;
determining a bounding box of the mapping points according to the coordinates of the mapping points;
if there is an overlapping area between the bounding box of the mapping points and a visible range corresponding to the viewport, determining that the tile falls within the visible range;
obtaining the tile that falls within the visible range, and performing display processing on the tile.

20. The non-transitory computer-readable storage medium according to claim 19, wherein the computer is caused to execute:
determining the bounding box of the tile according to the coordinates of the vertexes of the tile comprised in the panoramic map data;
mapping vertexes of the bounding box of the tile to the plane where the viewport is located, to obtain the coordinates of the mapping points.
